(19) United States
(12) Patent Application Publication
(10) Pub. No.: US 2004/0159047 A1
(43) Pub. Date: Aug. 19, 2004

(54) Drive system

(75) Inventors: Steven P. Heffner, La Grange, IL (US); Peter Heidrich, Niles, IL (US); Robert L. Oakley, Chicago, IL (US)

Correspondence Address: JAMES RAY & ASSOCIATES, 2640 Pitcairn Road, Monroeville, PA, 15146, US

(73) Assignee: WESTINGHOUSE AIR BRAKE TECHNOLOGIES CORPORATION

(21) Appl. No.: 10/782,639

(22) Filed: Feb. 19, 2004

Related U.S. Application Data
(62) Division of application No. 09/951,492, filed on Sep. 12, 2001, now abandoned.
(60) Provisional application No. 60/232,381, filed on Sep. 14, 2000.

(51) Int. Cl. E05C 3/06; E05F 11/34; E05F 11/40

(52) U.S. Cl. 49/362

(57) ABSTRACT

A mechanical power conversion device for receiving rotary power from a rotary power supply and delivering two independent power outputs, the conversion device having: a drive screw connectable to the rotary power supply, a drive nut engaging the drive screw to receive a drive nut axial force and drive nut torsion therefrom, the drive nut axial force being parallel to the drive screw and the drive nut torsion being about an axis of the drive screw. One of the two independent power outputs is connected to the drive nut to receive the drive nut axial force and the second is connected to the drive nut to receive the drive nut torsion so that power from the rotary power supply flows to either or both of the first independent power output and the second independent power output.

### CROSS-REFERENCE TO RELATED APPLICATIONS

The invention described in this patent application is based on DRIVE SYSTEM, Ser. No. 60/232,381, filed on Sep. 14, 2001.

### FIELD OF THE INVENTION

The present invention relates, in general, to drive systems for moving a load along a curved track and, more particularly, relates to sliding plug doors for transit vehicles.

### BACKGROUND OF THE INVENTION

Sliding plug doors for transit vehicles require a drive system which can move the doors along a curved path. When such a door is in its closed position, it is substantially flush with the side wall of the vehicle. When it is opened, it initially moves outward, and then moves longitudinally, along the wall, outside the vehicle. Such doors, generally, are guided in that curved motion by rollers engaging a curved track.

A drive for such a door includes a motor which is connected to a power conversion unit which applies motive power in both the outward and longitudinal directions, so that the door travels along the curved track.

U.S. Pat. No. 5,893,236 Power Operator for Sliding Plug Doors teaches a door drive employing a planetary gear drive. The planetary gear drive is powered by an electric motor connected to the planetary gear drive. The output shaft of the planetary gear drive has a pinion gear which engages a gear on the drive screw which provides the longitudinal motion. The planetary output gear is connected to a plug/unplug lever to provide motion in and out of the wall of the vehicle. When the door is in the closed position and is energized to open the door, power flows to the planetary output gear to move the door out of the wall of the vehicle. Then, as the door moves along the track, power flows to the drive screw which is connected to a door hanger to move the door longitudinally.

Additional prior art is provided by U.S. Pat. No. 5,893,236 which teaches a drive nut bracket having the form of a pivoted fork. The fork engages flats on the drive nut to prevent rotation of the drive nut, and to receive axial forces from the drive nut. The fork is connected to a door hanger which supports a transit vehicle door.

The teachings of these referenced patent applications are herein incorporated into the present application by reference thereto.

An additional aspect of the prior art is mechanical power conversion devices which receive a power input and provide two or more independent power outputs. The differential in an automobile, for example, receives rotary power from the driveshaft and provides two independent rotary power outputs for the two wheels. The outputs to the wheels are independent inasmuch as one wheel can rotate faster than the other, while they both receive torque from the differential. In general, such devices have an input-output relationship as follows.

F1*V1=F2*V2+F3*V3+(Friction power loss) (1)

The forces F1, F2, and F3 are generalized forces. The velocities are generalized velocities which are conjugate to the generalized forces. That is, any of the forces, multiplied by its corresponding velocity, represents power.

For an automobile differential, F1 would represent driveshaft torque and V1 would represent angular velocity of the driveshaft. F2 and F3 are the torques applied to the two rear wheels and V2 and V3 are the corresponding angular velocities of the wheels.

Typically, for an automobile, V2 and V3 are comparable in magnitude and V3 would, typically, be approximately three times as great as either.

Another mechanical power conversion device which conforms to Equation (1) is a planetary gear drive. Such a device receives rotary power on a power input shaft, represented as F1*V1 and provides F2*V2 on a power output shaft, as well as F3*V3 on a planetary output gear.

U.S. Pat. No. 5,893,236 (cited above) employs a planetary gear drive to move a plug door out of the sidewall of the transit vehicle, and then move it along the side of the vehicle. The power output shaft of the planetary gear drive is connected to a drive screw, which communicates a longitudinal force to the door. The planetary output gear engages a pinion which, when rotated, moves the door in and out of the wall of the vehicle. A curved track having a J-shaped track, guides the door out of the wall of the vehicle, and then along the wall.

### OBJECTS OF THE INVENTION

It is therefore one of the primary objects of the present invention to provide a rotary power conversion device which receives rotary power as input and provides a plurality of independent power outputs.

Another object of the present invention is to provide a plug door system for a transit vehicle which provides movement in and out of the wall of the vehicle and also movement parallel to the wall.

Still another object of the present invention is to provide a plug door for a transit vehicle which does not require a planetary gear drive connected to move the door in and out of the wall of the vehicle.

Yet another object of the present invention is to provide a plug door system for a transit vehicle which has fewer components than prior art door systems.

In addition to the various objects and advantages of the present invention which have been generally described above, there will be various other objects and advantages of the invention that will become more readily apparent to those persons who are skilled in the relevant art from the following more detailed description of the invention, particularly, when the detailed description is taken in conjunction with the attached drawing figures and with the appended claims.

### BRIEF DESCRIPTION OF THE DRAWINGS

FIG. 1 is a perspective view of the presently preferred embodiment of the invention which is a transit vehicle plug door drive. The view is taken from inside the vehicle and above the door drive. The drive is shown positioned so that doors (not shown) would be closed.

FIG. 2 is a perspective view of the left end of the unit, viewing from inside the vehicle.

FIG. 3 is an elevation view from outside the vehicle.

FIG. 4 is an illustration of a portion of an alternative embodiment in which the doors (not shown) are in their closed positions.

FIG. 5 is an illustration of the embodiment of FIG. 4 in which the doors are in their opened positions.

### BRIEF DESCRIPTION OF THE PRESENTLY PREFERRED AND VARIOUS ALTERNATIVE EMBODIMENTS OF THE INVENTION

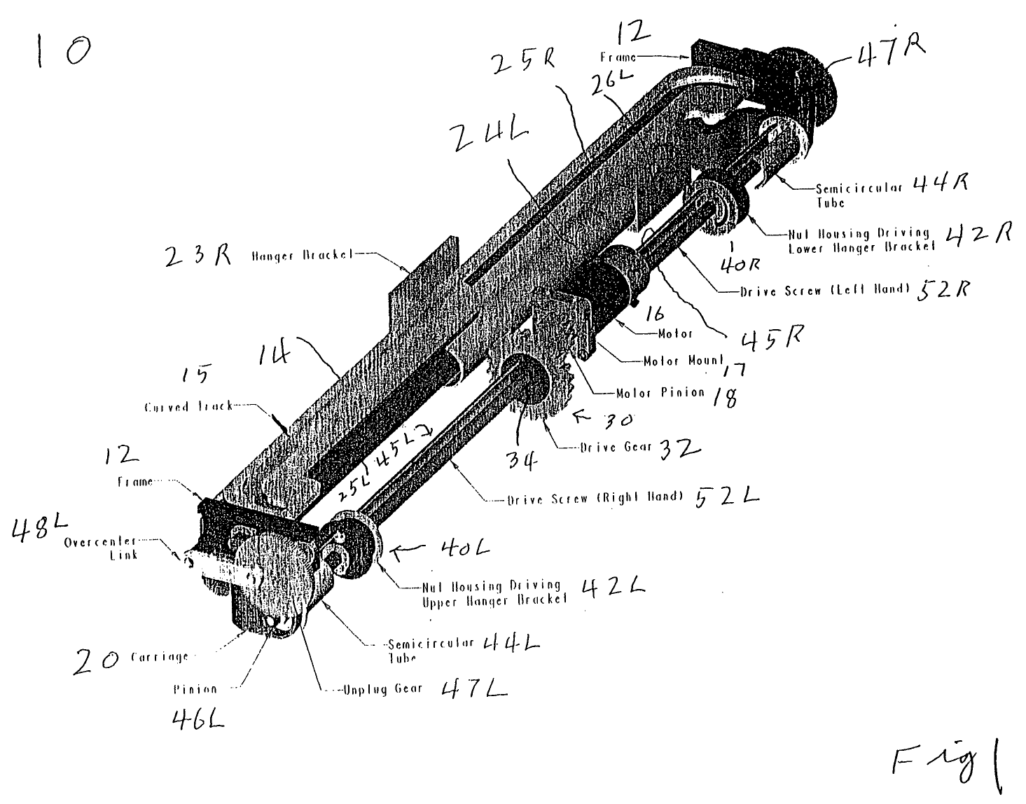

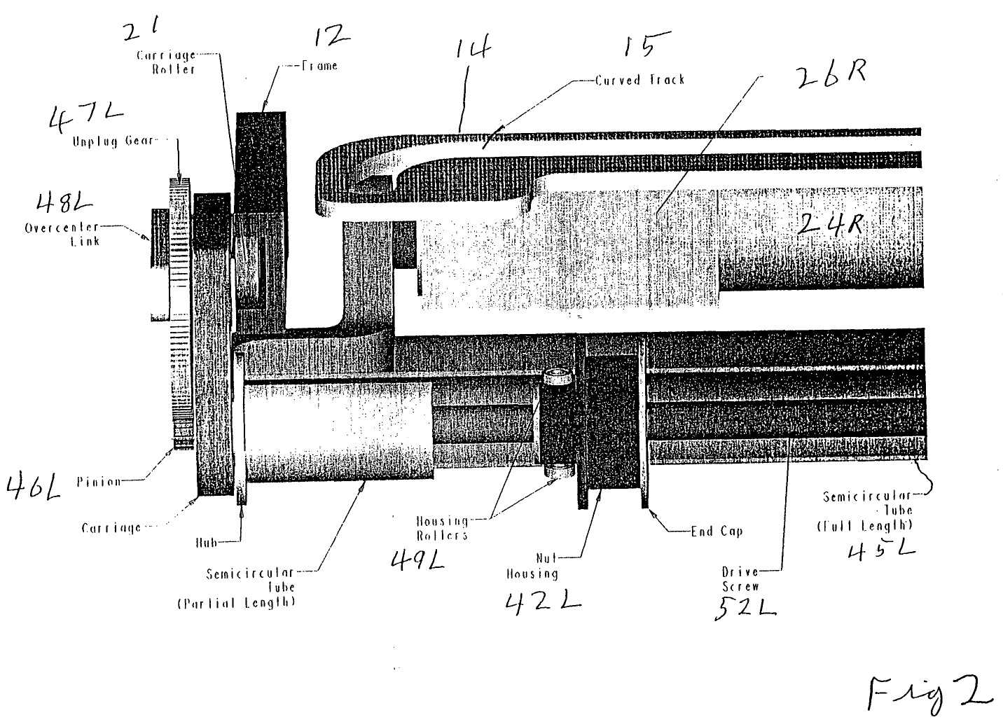

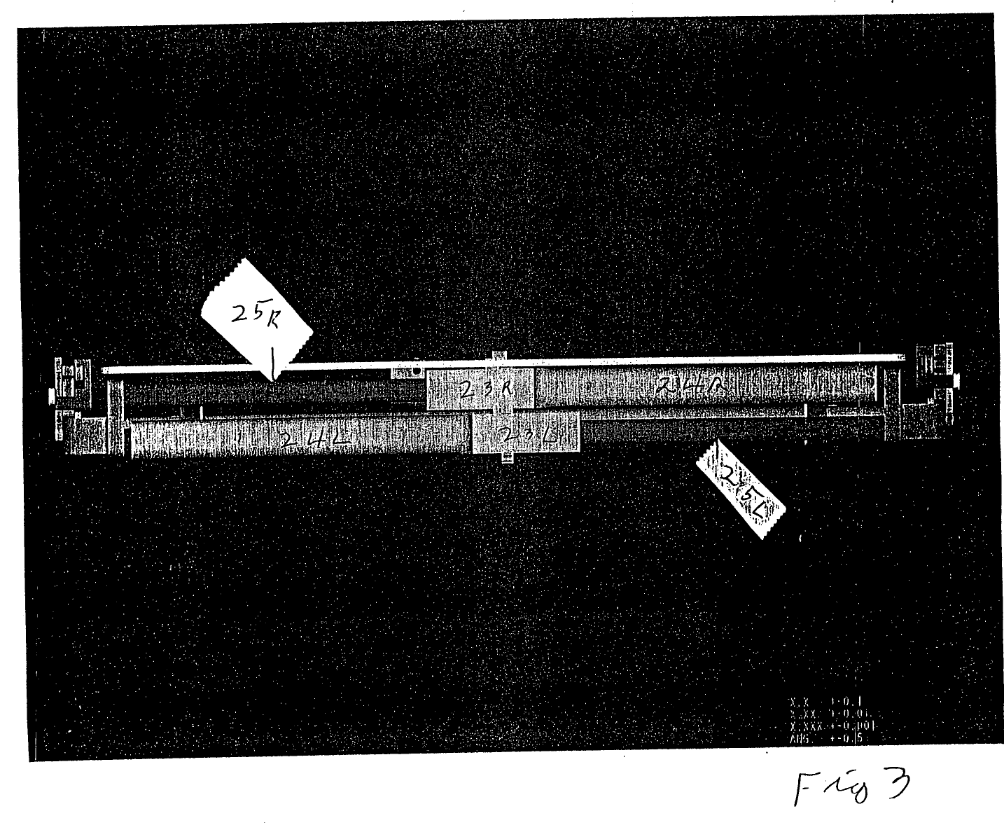

Attention is now directed to FIG. 1, with reference to FIGS. 2 and 3. A door operator 10 for a transit vehicle door drive, which is the presently preferred embodiment of the invention is illustrated in these figures. Door operator 10 has a carriage 20 mounted for movement on frame 12 by carriage rollers 21.

A curved track member 14 having a curved track 15 is connected to frame 12. Frame 12 and curved track member 14 are stationary with respect to the transit vehicle. Carriage 20, which carries the other components shown, moves in and out of an opening (not shown) in a sidewall (not shown) in a transit vehicle (not shown).

Additional general features include drive gear assembly 30, left drive nut assembly 40L and right drivenut assembly 40R.

A motor 16 is mounted on a motor base 17, which is mounted on carriage 20. (This connection is not shown). Motor 20 drives motor pinion 18, which engages drive gear 32. Drive gear 32 is captured between left drive screw 52L, which has a right hand thread and right drive screw 52R, which has a left hand thread. Drive gear 32 is mounted on a deep groove ball bearing (not shown) around independently rotating center 34.

Drive nut assembly 40L engages left drive screw 52L to receive axial force and torsion therefrom. Drive nut assembly 40R engages right drive screw 52R to receive axial force and torsion therefrom.

A right door panel (not shown) is supported on right hanger bracket 23R. A left door panel (not shown) is supported on left hanger bracket 23L. In FIG. 3, it can be seen that 23R is situated above 23L. Left hanger bracket 23L is supported by linear bearing 24L on the lower support rod, 25L. The right hanger bracket 23R is supported by linear bearing 25R on the upper support rod, 25R.

Linear bearing 24L has a flat surface 26L to which a drive nut fork (not shown) is attached. This drive nut fork engages right drive nut housing 42R to communicate axial forces to linear bearing 24L to move the left door panel (not shown).

A similar flat surface (not shown) on linear bearing 24R carries a drive nut fork (not shown) engaging left drive nut housing 42L to communicate axial forces to linear bearing 24R to move the right door panel (not shown).

The Left partial length semicircular tube 44L and left full length semicircular tube 45L pass through semicircular cuts in left drive nut housing 42L to receive torsion from the left drive nut (not seen, inside left drive nut assembly 40L).

Likewise, the right partial length semicircular tube 44R and right full length semicircular tube 45R pass through semicircular cuts in right drive nut housing 42R to receive torsion from the right drive nut (not seen, inside right drive nut assembly 40R).

Semicircular tubes 44L and 44R communication torsion to left pinion 46L, which engages left unplug gear 47L. A left overcenter link 40L connected to left unplug gear 47L to move carriage 20 in and out of the transit vehicle wall (not shown). Since 48L is an overcenter link, it provides for locking the doors in closed positions.

Similarly, semicircular tubes 44R and 45R exert torsion on a pinion 46R (not shown) which engages unplug gear 47R.

Torsion is communicated between semicircular tubes 44L and 45L by rollers 49L on left drive nut assembly 40L. A similar arrangement for the right drive nut assembly 40R is now shown.

FIGS. 1, 2 and 3 show the system with the doors in a closed position. When motor 16 is first energized to open the doors, rollers for the linear bearings 24L and 24R are in the curved end portions of track 15. This prevents the doors from opening, but allows the carriage 20 to move out of the wall of the transit vehicle. This movement is energized by torsion communicated by the drive nuts to the semicircular tubes, thence to the pinions 46L and a similar pinion on the right to the unplug gears 47L and 47R, which pull on the overcenter link 48L and a similar link on the right.

When the carriage 20 is displaced out of the transit vehicle wall, the rollers in curved track 15 are in the straight portions, the doors move apart. This movement is energized by axial forces communicated from drive nut assemblies 40L and 40R to the forks (not shown) attached to surface 26L on linear bearing 24L and a similar surface on linear bearing 24R.

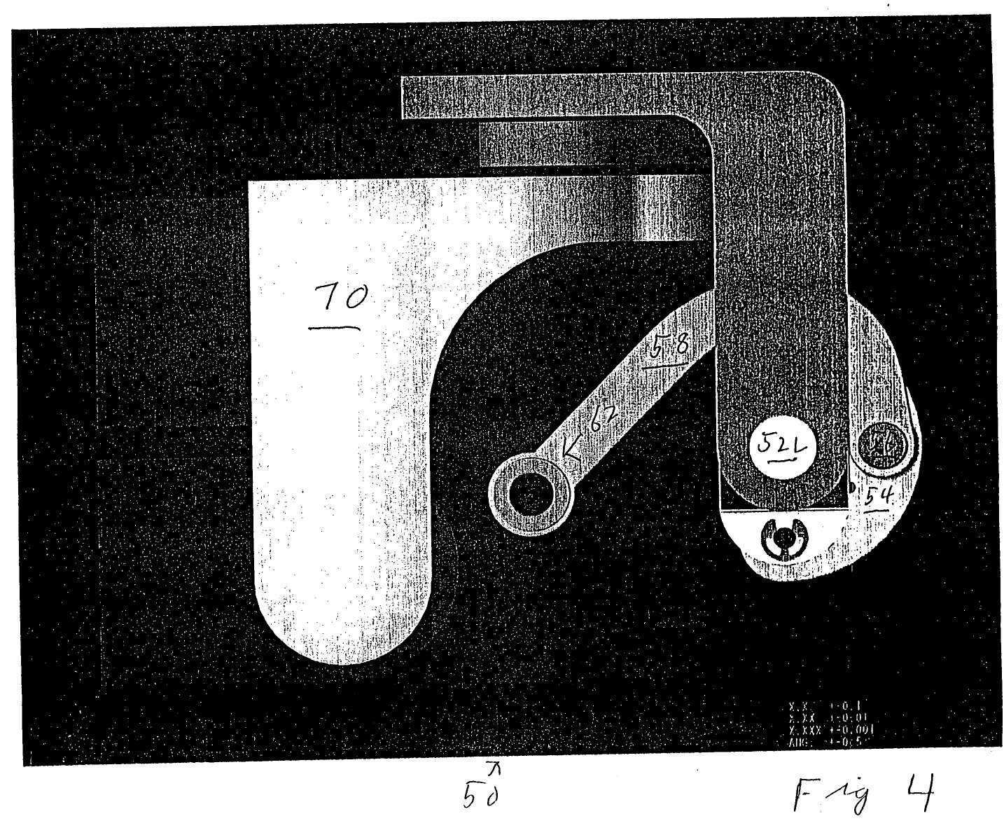

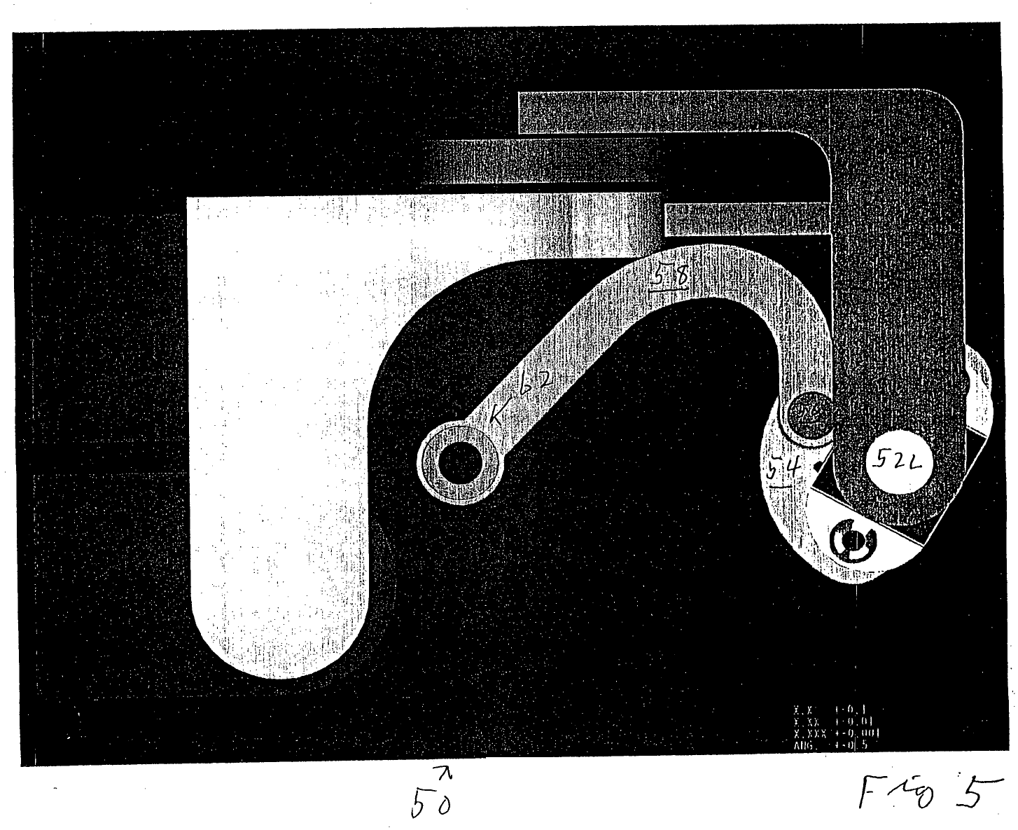

An alternative embodiment which, presently, is not preferred is shown in FIGS. 4 and 5. An alternative mechanism for applying plug/unplug forces to carriage 20 is denoted 50. Right drive nut assembly 40R has an eccentric member 54 having a connection 56. Torsion communicated to the drive nut causes eccentric member 54 to rotate to the position shown in FIG. 5. This rotation causes connection 56 to move from the right side in FIG. 4 to the left side shown in FIG. 5.

For this embodiment, drive screws 52L and 52R do not move with carriage 20. They are fixed relative to the transit vehicle.

Curved link 58 is attached to connection 56 and to second connection 62 which is attached in such a way as to move carriage 20. That movement is a plug or unplug movement.

### Description of Plug Door Operator Drive

The door operator functions as follows:

The drive gear, motor pinion, and motor are all mounted on the motor mount. (FIG. 1)

The motor pinion drives the main gear, which is captured between the right hand and left hand drive screws. This arrangement evenly distributes the load on each half of the drive screw.

Mounted on the gear is a deep groove ball bearing, which takes the radial and thrust loads generated by the drive screw and gear.

The drive screw itself is a multi-start, long lead, rolled thread stainless steel screw.

The drive screw engages replaceable nut halves, which are located in the nut housing. The nut halves and screw do not require any lubrication.

There are two nut housings, each driving its own hanger bracket. In the fully closed and locked position, the nut housings are located at the far ends of the drive screw.

The nut housing has a removable end cap (FIG. 2), allowing replacement of the drive nut halves.

The end cap captures the drive fork (not shown). The drive fork is the interface between the nut housing and the hanger bracket. It is mounted directly to the hanger bracket and has radial clearance between itself and the nut housing. This eliminates the need for a two-piece pivoting fork.

Mounted on the drive nut housing are two housing rollers (FIG. 2), which contact the semicircular tube (full length) providing antirotation for the nut housing.

The hanger bracket (FIG. 2) is guided by a roller (not shown) which engages the curved track. When the curved track roller comes into the curved portion of the track, it allows the drive nut housing to rotate. By this time, the housing rollers have engaged the semicircular tube (partial length).

The two semicircular tubes are rigidly attached to the hub on which resides a pinion. The drive nut housing rotates the semicircular tube also rotating the pinion.

The pinion (FIG. 1) in turn rotates the unplug gear at a ration of 1:6, providing the torque necessary to unplug the system. The unplug gear rotates 150° while the pinion goes through 2.5 revolutions.

Mounted on the unplug gear is an overcenter link. The other side of the link is mounted to the frame (which is stationary with respect to the car structure). The link creates an overcenter lock between the frame and the carriage. When the unplug gear rotates, it effectively pulls itself forward along with the rest of the system.

The drive screw and hanger brackets move inboard and outboard together because they are both mounted to the carriage (FIG. 2).

The carriage is supported by the carriage rollers (FIG. 2), which roll in the frame.

While a presently preferred embodiment for carrying out the instant invention has been set forth in detail in accordance with the Patent Act, those persons skilled in the drive system art to which this invention pertains will recognize various alternative ways of practicing the invention without departing from the spirit and scope of the claims appended hereto.

We claim:

1. A mechanical power conversion device for receiving rotary power from a rotary power supply and delivering two independent power outputs, said conversion device comprising:
(a) a drive screw connectable to said rotary power supply;
(b) a drive nut engaging said drive screw to receive a drive nut axial force and drive nut torsion therefrom, said drive nut axial force being parallel to said drive screw and said drive nut torsion being about an axis of said drive screw;
(c) a first of said two independent power outputs connected to said drive nut to receive said drive nut axial force from said drive nut;
(d) a second of said two independent power outputs connected to said drive nut to receive said drive nut torsion;
(e) whereby power from said rotary power supply flows to either or both of said first independent power output and said second independent power output.

2. A plug door system for a transit vehicle having a sidewall and a door opening in said sidewall, said plug door system comprising:
(a) a sliding door;
(b) a carriage having a beam, rod or track for supporting said sliding door;
(c) a rotary power supply;
(d) a drive screw connected to said rotary power supply;
(e) a drive nut engaging said drive screw to receive a drive nut axial force and drive nut torsion from said drive screw;
(f) a drive nut bracket engaging said drive nut to receive said drive nut axial force from said drive nut, said drive nut bracket attached to said sliding door or a hanger for said sliding door;
(g) a torsion receiving device connected to said drive nut to receive said drive nut torsion therefrom;
(h) a carriage displacing means connected to said torsion receiving device, said carriage displacing means moving said carriage into and out of a said opening in said sidewall;
(i) a curved track to guide said sliding door so that when said door is opened, said carriage and door move out of said opening and then said door moves axially, along said sidewall of said transit vehicle.

3. A plug door system, according to claim 2, wherein said door system further includes a second sliding door mounted on said carriage to constitute a biparting door system, said second sliding door being moved in a second axial direction, opposite to said first sliding door by a second drive screw having a pitch opposite to said first drive screw, said second drive screw connected to rotate at the same speed as said first drive screw, a second drive nut engaging said second drive screw to receive a second drive nut axial force and a second drive nut torsion from said drive screw, said plug door system having a second drive nut bracket engaging said second drive nut and connected to said second sliding door to convey said second drive nut axial force to said second sliding door, said plug door system having a second carriage displacing means connected to said carriage and connected to a second torsion receiving device, said second torsion receiving device receiving said second drive nut torsion from said second drive nut.

4. A plug door system, according to claim 2, wherein said door system further includes at least one curved track for guiding rollers attached to said door so that upon opening, said door first move outwardly as said carriage moves outwardly and then move longitudinally along said side wall of said vehicle in opposite directions.

5. A plug door system, according to claim 3, wherein said door system further includes at least one curved track for guiding rollers attached to said doors so that upon opening, said doors first move outwardly as said carriage moves outwardly and then move longitudinally along said side wall of said vehicle in opposite directions.

6. A plug door system, according to claim 2, wherein said drive nut torsion is received by pinions which rotate a crank attached to a link to move said carriage into and out of said opening.

7. A plug door system, according to claim 3, wherein said drive nut torsions are received by pinions which rotate cranks attached to links to move said carriage into and out of said opening.

8. A plug door system, according to claim 2, wherein said drive nut torsion is received by a link which move said carriage into and out of said opening.

9. A plug door system, according to claim 3, wherein said drive nut torsions are received by links which move said carriage into and out of said opening.

10. A plug door system, according to claim 7, wherein said link is an overcenter link to lock said door when closed.

11. A plug door system, according to claim 8, wherein said links are overcenter links to lock said doors when closed.
